(19) United States
(12) Patent Application Publication
(10) Pub. No.: US 2019/0365126 A1
(43) Pub. Date: Dec. 5, 2019

(54) Pet Utensil Kit

(71) Applicant: Ruby Irene Carter, Los Angeles, CA (US)

(72) Inventor: Ruby Irene Carter, Los Angeles, CA (US)

(21) Appl. No.: 15/997,900

(22) Filed: Jun. 5, 2018

(51) Int. Cl. A47G 21/00; A01K 5/00; A47G 21/02; A47G 21/04

(52) U.S. Cl. CPC A47G 21/00; A01K 5/00; A47G 21/06; A47G 21/04; A47G 21/023

(57) ABSTRACT

A pet utensil kit for preparing and serving food for a pet includes a plurality of implements. Each implement comprises a handle and a tool. The tool is coupled to and extends from a first end of the handle. The handle is configured to be grasped in a hand of a user, positioning the user to manipulate the tool to prepare food and to serve the food to a pet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to utensil kits and more particularly pertains to a new utensil kit for preparing and serving food for a pet.

### BRIEF SUMMARY OF THE INVENTION

An embodiment of the disclosure meets the needs presented above by generally comprising a plurality of implements. Each implement comprises a handle and a tool. The tool is coupled to and extends from a first end of the handle. The handle is configured to be grasped in a hand of a user, positioning the user to manipulate the tool to prepare food and to serve the food to a pet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pet utensil kit according to an embodiment of the disclosure.

FIG. 2 is a top view of an embodiment of the disclosure.

FIG. 3 is an in-use view of an embodiment of the disclosure.

### DETAILED DESCRIPTION OF THE INVENTION

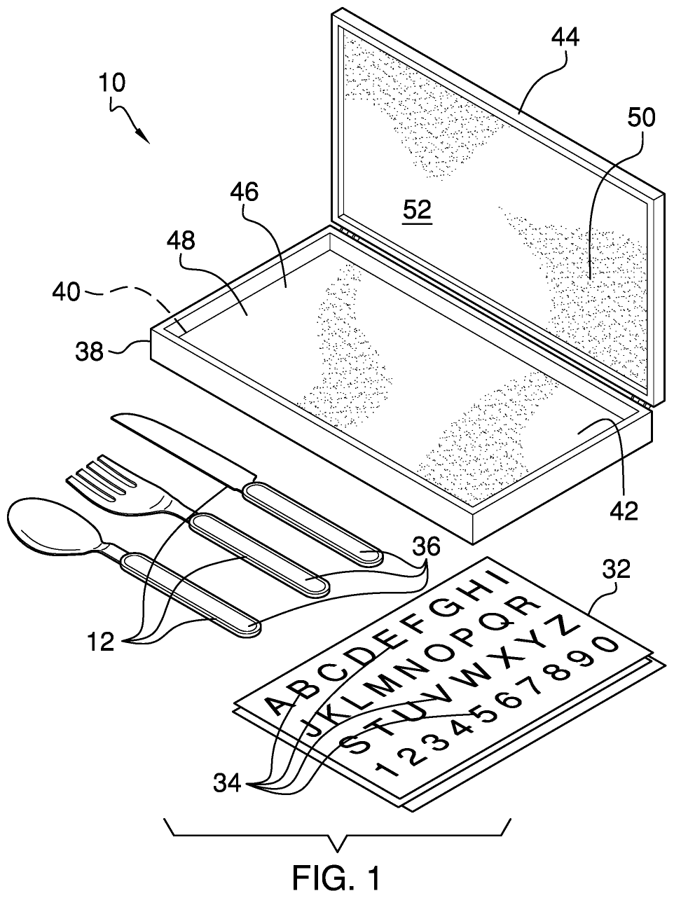

With reference now to the drawings, and in particular to FIGS. 1 through 3 thereof, a new utensil kit embodying the principles and concepts of an embodiment of the disclosure and generally designated by the reference numeral 10 will be described.

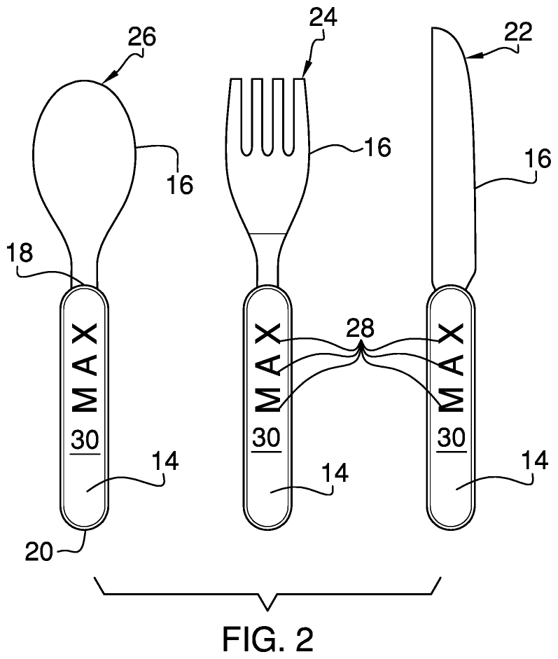

As best illustrated in FIGS. 1 through 3, the pet utensil kit 10 generally comprises a plurality of implements 12. Each implement 12 comprises a handle 14 and a tool 16. The tool 16 is coupled to and extends from a first end 18 of the handle 14. The handle 14 is configured to be grasped in a hand of a user, positioning the user to manipulate the tool 16 to prepare food and to serve the food to a pet. The handle 14 has a second end 20. The second end 20 is arcuate to facilitate handling of the implement 12. The plurality of implements 12 comprises a knife 22, a fork 24, and a spoon 26, as shown in FIG. 2.

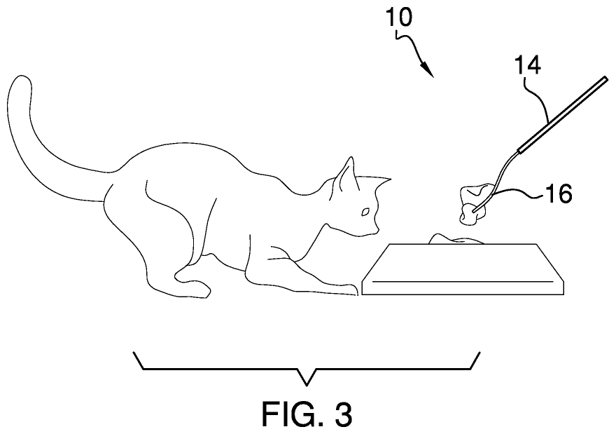

Each of a plurality of sets of indicia 28 is coupled to a top face 30 of a respective handle 14. The set of indicia 28 is configured to identify the implement 12 that comprises the respective handle 14 as an implement 12 to be used exclusively to prepare the food and to serve the food to the pet, as shown in FIG. 3. The set of indicia 28 comprises a name of the pet, as shown in FIG. 2.

The kit 10 also comprises a sheet 32 and a plurality of stickers 34, as shown in FIG. 1. Each sticker 34 has a respective shape so that the plurality of stickers 34 comprises shapes of the letters of the alphabet and the numbers zero through ten. Each sticker 34 is removably and adhesively coupled to the sheet 32. Respective stickers 34 are positioned to be removed from the sheet 32 so that the respective stickers 34 are positioned to be adhesively coupled to the respective handle 14. The respective stickers 34 comprise the set of indicia 28 and are configured to identify the implement 12 that comprises the respective handle 14 as an implement 12 to be used exclusively to prepare the food and to serve the food to the pet. In this manner, the implements 12 used in preparing and serving the food to the pet are not confused with the utensils used by humans.

Each of a plurality of recesses 36 is positioned in the top face 30 of a respective handle 14, as shown in FIG. 2. The respective handle 14 is configured to be engraved within the recess 36 with a respective set of indicia 28 to identify the implement 12 that comprises the respective handle 14 as an implement 12 to be used exclusively to prepare the food and to serve the food to the pet.

The kit 10 also comprises a shell 38 that defines an interior space 40, as shown in FIG. 1. The shell 38 has a top 42 that is open so that the top 42 is positioned to selectively insert the plurality of implements 12 into the interior space 40 to store the implements 12. The shell 38 is rectangularly box shaped.

A lid 44 is hingedly coupled to the shell 38 proximate to the top 42. The lid 44 is complementary to the top 42. The lid 44 is configured to be selectively pivoted relative to the shell 38 to close the top 42.

A first pad 46 is coupled to the shell 38 and positioned in the interior space 40. The first pad 46 is positioned on a bottom 48 of the shell 38. A second pad 50 is coupled to an inner surface 52 of the lid 44. The first pad 46 and the second pad 50 are positioned to cushion the plurality of implements 12.

In use, the implements 12 are used to prepare the food and to serve the food to the pet. The sets of indicia 28 identify the implements 12 for use exclusively to prepare the food and to serve the food to the pet. In this manner, the implements 12 used in preparing and serving the food to the pet are not confused with the utensils used by humans.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet utensil kit comprising a plurality of implements, each implement comprising a handle and a tool, the tool being coupled to and extending from a first end of the handle wherein the handle is configured for grasping in a hand of a user positioning the user for manipulating the tool for preparing and serving food to a pet.

2. The kit of claim 1, further including the plurality of implements comprising a knife, a fork, and a spoon.

3. The kit of claim 1, further including a plurality of sets of indicia, each set of indicia being coupled to a top face of a respective handle wherein the set of indicia is configured for identifying the implement comprising the respective handle as an implement for exclusive use for preparing and serving the food to the pet.

4. The kit of claim 3, further including the set of indicia comprising a name of the pet.

5. The kit of claim 3, further including comprising:
a sheet; and
a plurality of stickers, each sticker having a respective shape such that the plurality of stickers comprises shapes of the letters of the alphabet and the numbers zero through ten, each sticker being removably adhesively coupled to the sheet wherein respective stickers are positioned for removing from the sheet positioning the respective stickers for being adhesively coupled to the respective handle such that the respective stickers comprise the set of indicia wherein the set of indicia is configured for identifying the implement comprising the respective handle as an implement for exclusive use for preparing and serving the food to the pet.

6. The kit of claim 3, further including a plurality of recesses, each recess being positioned in the top face of a respective handle wherein the respective handle is configured for being engraved within the recess with a respective set of indicia for identifying the implement comprising the respective handle as an implement for exclusive use for preparing and serving the food to the pet.

7. The kit of claim 1, further comprising:
a shell defining an interior space, the shell having a top, the top being open wherein the top is positioned for selectively inserting the plurality of implements into the interior space for storing the implements; and
a lid hingedly coupled to the shell proximate to the top, the lid being complementary to the top wherein the lid is configured for selectively pivoting relative to the shell for closing the top.

8. The kit of claim 7, further including the shell being rectangularly box shaped.

9. The kit of claim 7, further comprising:
a first pad coupled to the shell and positioned in the interior space, the first pad being positioned on a bottom of the shell; and
a second pad coupled to an inner surface of the lid wherein the first pad and the second pad are positioned for cushioning the plurality of implements.

10. The kit of claim 1, further including the handle having a second end, the second end being arcuate.

11. A pet utensil kit comprising:
a plurality of implements, each implement comprising a handle and a tool, the tool being coupled to and extending from a first end of the handle wherein the handle is configured for grasping in a hand of a user positioning the user for manipulating the tool for preparing and serving food to a pet, the handle having a second end, the second end being arcuate, the plurality of implements comprising a knife, a fork, and a spoon;
a plurality of sets of indicia, each set of indicia being coupled to a top face of a respective handle wherein the set of indicia is configured for identifying the implement comprising the respective handle as an implement for exclusive use for preparing and serving the food to the pet, the set of indicia comprising a name of the pet;
a sheet;
a plurality of stickers, each sticker having a respective shape such that the plurality of stickers comprises shapes of the letters of the alphabet and the numbers zero through ten, each sticker being removably adhesively coupled to the sheet wherein respective stickers are positioned for removing from the sheet positioning the respective stickers for being adhesively coupled to the respective handle such that the respective stickers comprise the set of indicia wherein the set of indicia is configured for identifying the implement comprising the respective handle as an implement for exclusive use for preparing and serving the food to the pet;
a plurality of recesses, each recess being positioned in the top face of a respective handle wherein the respective handle is configured for being engraved within the recess with a respective set of indicia for identifying the implement comprising the respective handle as an implement for exclusive use for preparing and serving the food to the pet;
a shell defining an interior space, the shell having a top, the top being open wherein the top is positioned for selectively inserting the plurality of implements into the interior space for storing the implements, the shell being rectangularly box shaped;
a lid hingedly coupled to the shell proximate to the top, the lid being complementary to the top wherein the lid is configured for selectively pivoting relative to the shell for closing the top;
a first pad coupled to the shell and positioned in the interior space, the first pad being positioned on a bottom of the shell; and
a second pad coupled to an inner surface of the lid wherein the first pad and the second pad are positioned for cushioning the plurality of implements.
